(19) United States
(12) Patent Application Publication
(10) Pub. No.: US 2025/0182382 A1
(43) Pub. Date: Jun. 5, 2025

(54) PROGRESSIVE NULL TRACKING FOR VOLUMETRIC RENDERING

(71) Applicant: DISNEY ENTERPRISES, INC., Burbank, CA (US)

(72) Inventors: Yining Karl LI, Burbank, CA (US); Brent David BURLEY, Monterey Park, CA (US); Daniel Stuart TEECE, Pasadena, CA (US); Zackary Timber MISSO, Cedar Park, TX (US)

(21) Appl. No.: 18/528,658

(22) Filed: Dec. 4, 2023

(51) Int. Cl. G06T 15/08; G06T 15/06

(52) U.S. Cl. CPC G06T 15/08; G06T 15/06

(57) ABSTRACT

The present invention sets forth a technique for rendering a volumetric medium. The technique includes generating, in a first rendering pass, a first set of pixel values associated with rendering the volumetric medium using a first upper bound on a density of the volumetric medium. The technique also includes generating, in a second rendering pass, a second set of pixel values associated with rendering the volumetric medium using a second upper bound on the density of the volumetric medium, wherein the second upper bound is different from the first upper bound. The technique further includes generating a rendering of the volumetric medium based on the first set of pixel values and the second set of pixel values.

### BACKGROUND

### Field of the Various Embodiments

Embodiments of the present disclosure relate generally to volumetric rendering and, more specifically, to progressive null tracking for volumetric rendering.

### Description of the Related Art

Volumetric rendering refers to the process of generating images that depict the propagation of light within a three-dimensional (3D) volumetric medium occupied by a certain type of material or object. For example, volumetric rendering techniques can be used to simulate the interaction of light with fog, smoke, water, clouds, plasma, biological tissue, and/or another medium that can vary in density. These volumetric rendering techniques typically involve propagating rays of light into the volumetric medium and estimating the way in which the light is transmitted, scattered, emitted, and/or absorbed within the medium.

Certain state-of-the-art techniques for performing volumetric rendering, which are referred to as null-collision approaches, determine absorption, emission, scattering, and/or other interactions between light and matter using predefined upper bounds (which can also be referred to as “majorants” or “bounding extinctions”) on the density of the volumetric media at various points or regions in the 3D volume. However, in studio and production settings, volumetric media are frequently defined in a procedural manner using “black box” mathematical functions, physical simulations, artistic workflows, and/or other external manipulations. While these “black box” processes can be used to evaluate the density of a volumetric medium at specific points, bounds on the density of the volumetric medium across the entire 3D volume cannot be determined in an exact manner.

Because the density of a procedurally generated volumetric medium cannot be explicitly specified, null-collision-based techniques frequently render the volumetric medium by evaluating the density at specific points within the volumetric medium. For example, the density of the volumetric medium could be evaluated at points along a fixed grid that spans the 3D space occupied by the volumetric medium. These point-based density estimates could then be used to compute tight upper bounds on the density of the procedurally generated volumetric medium at corresponding locations or regions within the volumetric medium. As the granularity of the grid increases, the accuracy and quality of the rendering improves.

However, each point-based evaluation of density within a procedurally generated volumetric medium increases the resource overhead associated with rendering the volumetric medium. Continuing with the above example, an increase in the number of grid points at which the density of the volumetric medium is evaluated would increase the resolution and level of detail in the corresponding render. On the other hand, the density evaluated at each grid point would also incur a certain computational cost and a corresponding storage cost. Thus, a tradeoff exists between accuracy and efficiency in null-collision volumetric rendering of a procedurally generated volumetric medium.

At the same time, evaluations of density at specific points within a volumetric medium are not guaranteed to find the true upper bound on the density across the entire volumetric medium. Instead, these point-based density evaluations typically underestimate the upper bound on the density within the volumetric medium, which can also reduce rendering quality. More specifically, upper bounds on the density of a volumetric medium are used by conventional null-collision-based volumetric rendering techniques to compute estimates of the transmission and scattering of light within the volumetric medium. When these upper bounds are lower than the actual density of the volumetric medium, the error associated with the estimated transmission and scattering of light can increase over time and cause the resulting rendering to become increasingly noisy, inaccurate, and unusable.

One approach to avoiding underestimates of upper bounds on densities within volumetric media is to set a “loose” (e.g., high) upper bound on the density of a given volumetric medium. However, a loose upper bound on the density of the volumetric medium also increases the number of estimates and computations related to interactions between light and the volumetric medium. Consequently, significant additional resource overhead can be incurred when null-collision-based volumetric rendering is performed using a loose upper bound on the density of a volumetric medium.

As the foregoing illustrates, what is needed in the art are more effective techniques for rendering procedurally generated volumetric media.

### SUMMARY

One embodiment of the present invention sets forth a technique for rendering a volumetric medium. The technique includes generating, in a first rendering pass, a first set of pixel values associated with rendering the volumetric medium using a first upper bound on a density of the volumetric medium. The technique also includes generating, in a second rendering pass, a second set of pixel values associated with rendering the volumetric medium using a second upper bound on the density of the volumetric medium, wherein the second upper bound is different from the first upper bound. The technique further includes generating a rendering of the volumetric medium based on of the first set of pixel values and the second set of pixel values.

One technical advantage of the disclosed techniques relative to the prior art is the ability to converge on the correct upper bound on the density of a volumetric medium over a finite number of iterations. Accordingly, the disclosed techniques allow null-collision-based rendering techniques to become resilient to underestimates of the upper bound, thereby improving rendering quality over conventional volumetric rendering techniques that introduce bias and/or variance in the presence of non-bounding majorants. Another technical advantage of the disclosed techniques is the ability to perform volumetric rendering without a priori knowledge about the density of a volumetric medium. Consequently, the disclosed techniques are more computationally efficient than conventional null-collision-based rendering techniques that specify loose upper bounds on the density of a volumetric medium and/or precompute and store density values at various locations in the volumetric medium. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram illustrating a computer system configured to implement one or more aspects of various embodiments.

FIG. 2 is a more detailed illustration of the analysis engine and rendering engine of FIG. 1, according to various embodiments.

FIG. 3 illustrates how the analysis engine of FIG. 1 iteratively evaluates densities associated with rendering of a volumetric medium, according to various embodiments.

FIG. 4 illustrates a set of example rendered images of a volumetric medium, according to various embodiments.

FIG. 5 sets forth a flow diagram of method steps for rendering a volumetric medium using a sequence of upper bounds on the density of the volumetric medium, according to various embodiments.

FIG. 6 sets forth a flow diagram of method steps for rendering a volumetric medium using an approximation of a null free-flight distribution, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

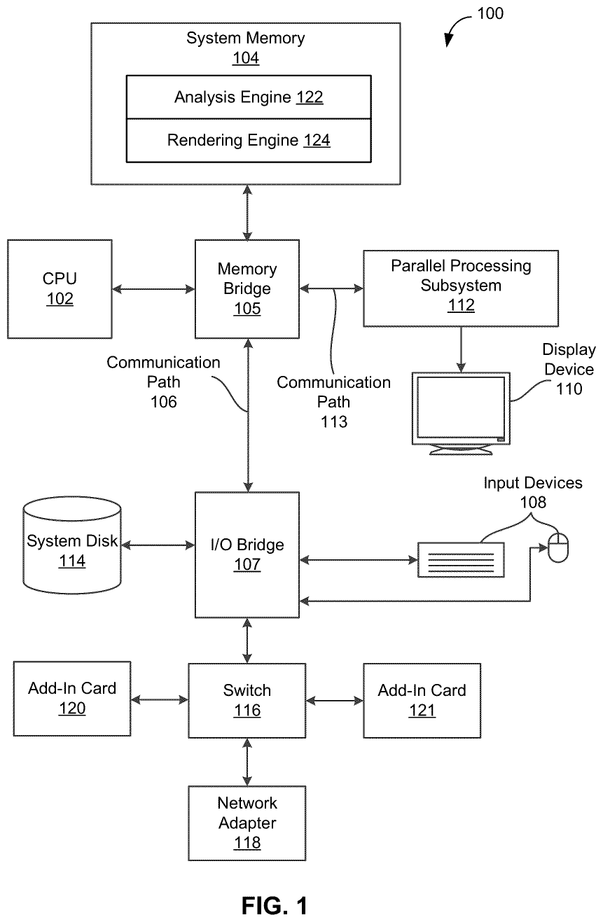

FIG. 1 is a block diagram illustrating a computer system 100 configured to implement one or more aspects of various embodiments. In one embodiment, computer system 100 includes a desktop computer, a laptop computer, a smart phone, a personal digital assistant (PDA), tablet computer, or any other type of computing device configured to receive input, process data, and optionally display images, and is suitable for practicing one or more embodiments. Computer system 100 also, or instead, includes a machine or processing node operating in a data center, cluster, or cloud computing environment that provides scalable computing resources (optionally as a service) over a network.

As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

I/O bridge 107 is configured to receive user input information from optional input devices 108, such as a keyboard, a microphone, or a mouse, and forward the input information to CPU 102 for processing via communication path 106 and memory bridge 105. In some embodiments, computer system 100 may be a server machine in a cloud computing environment. In such embodiments, computer system 100 may not have input devices 108. Instead, computer system 100 may receive equivalent input information by receiving commands in the form of messages transmitted over a network and received via the network adapter 118. In one embodiment, switch 116 is configured to provide connections between I/O bridge 107 and other components of the computer system 100, such as a network adapter 118 and various add-in cards 120 and 121.

In one embodiment, I/O bridge 107 is coupled to a system disk 114 that may be configured to store content and applications and data for use by CPU 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

In some embodiments, parallel processing subsystem 112 includes a graphics subsystem that delivers pixels to an optional display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. Such circuitry may be incorporated across one or more parallel processing units (PPUs), also referred to herein as parallel processors, included within parallel processing subsystem 112. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver configured to manage the processing operations of the one or more PPUs within parallel processing subsystem 112.

Parallel processing subsystem 112 may be integrated with one or more of the other elements of FIG. 1 to form a single system. For example, parallel processing subsystem 112 may be integrated with CPU 102 and other connection circuitry on a single chip to form a system on chip (SoC).

In one embodiment, CPU 102 is the master processor of computer system 100, controlling and coordinating operations of other system components. In one embodiment, CPU 102 issues commands that control the operation of PPUs. In some embodiments, communication path 113 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. First, the functionality of the system can be distributed across multiple nodes of a distributed and/or cloud computing system. Second, the connection topology, including the number and arrangement of bridges, the number of CPUs 102, and the number of parallel processing subsystems 112, can be modified as desired. For example, in some embodiments, system memory 104 could be connected to CPU 102 directly rather than through memory bridge 105, and other devices would communicate with system memory 104 via memory bridge 105 and CPU 102. In another example, parallel processing subsystem 112 may be connected to I/O bridge 107 or directly to CPU 102, rather than to memory bridge 105. In a third example, I/O bridge 107 and memory bridge 105 may be integrated into a single chip instead of existing as one or more discrete devices. Third one or more components shown in FIG. 1 may not be present. For example, switch 116 could be eliminated, and network adapter 118 and add-in cards 120, 121 would connect directly to I/O bridge 107.

In one or more embodiments, computer system 100 is configured to execute an analysis engine 122 and a rendering engine 124 that reside in system memory 104. Analysis engine 122 and rendering engine 124 may be stored in system disk 114 and/or other storage and loaded into system memory 104 when executed.

More specifically, analysis engine 122 and rendering engine 124 include functionality to perform progressive null tracking for volumetric rendering. Analysis engine 122 iteratively computes a sequence of values for an upper bound on the density of the volumetric medium. The upper bound for a given iteration is computed using real density values evaluated during the previous iteration and the upper bound from the previous iteration. Analysis engine 122 also uses the upper bound to sample free flight distances for rays of light traveling through the volumetric medium, determine real and null collisions associated with the free flight distances, and determine transmittances associated with the ray.

Rendering engine 124 renders multiple images of the volumetric medium based on density values, upper bounds, collisions, and/or other transmittances determined by analysis engine 122. More specifically, rendering engine 124 uses collisions and/or transmittances determined over a given iteration to determine the contributions of individual rays to light intensities, colors, and/or other pixel values in a corresponding image. Rendering engine 124 additionally aggregates multiple rendered images produced over the corresponding iterations into a final render output. As described in further detail below, this iterative and aggregated rendering approach improves the quality with which the volumetric medium is rendered while maintaining relatively low render times.

### Progressive Null Tracking and Null-Density-Based Sampling for Volumetric Rendering

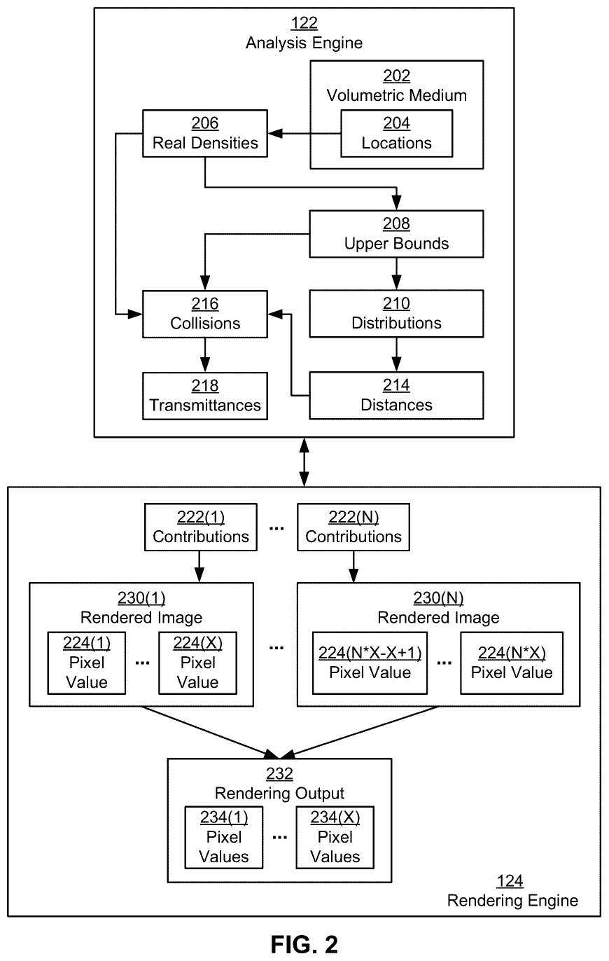

FIG. 2 is a more detailed illustration of analysis engine 122 and rendering engine 124 of FIG. 1, according to various embodiments. As mentioned above, analysis engine 122 and rendering engine 124 operate to perform null-collision-based rendering of a volumetric medium 202.

Volumetric medium 202 includes a three-dimensional (3D) volume occupied by a certain type of material or object. For example, volumetric medium 202 could include fog, smoke, water, clouds, plasma, biological tissue, and/or another material that can vary in density. To render volumetric medium 202, analysis engine 122 and rendering engine 124 propagate rays of light into volumetric medium 202 and estimate transmission, scattering, emission, absorption, and/or other interactions between the light and particles within volumetric medium 202.

During null-collision-based rendering of volumetric medium 202, the heterogeneous density of volumetric medium 202, as defined by a spatially varying absorption coefficient μₐ(x) and scattering coefficient μₛ(x), is combined with additional fictitious, or “null,” density μₙ(x) to create a locally homogeneous medium with a combined density, or “extinction,” of μₜ=μₙ(x)+μₐ(x)+μₛ(x). The amount of fictitious density at any location x is specified implicitly by taking the difference between the combined extinction μₜ(x) and the real density μᵣ(x)=μₐ(x)+μₛ(x). This constant combined density μₜ can be expressed as one or more upper bounds 208 on the density of volumetric medium 202 and allows volumetric medium 202 to be rendered using the same analytical sampling methods as those of homogeneous media.

More specifically, null-collision-based rendering of volumetric medium 202 involves computing the radiance arriving at a point x from a direction ω using the following Volume Rendering equation:

$$L ( x , ω ) = \overline{Tr} ( x , y ) {L}^{s} ( y , ω ) + {\int }_{x}^{y} p ( t ) {L}^{m} ( t , ω ) dt \qquad ( 1 )$$

In the above equation, L^{s}(y,ω) is the radiance leaving the nearest surface intersection y along a ray. This radiance is weighted by the combined transmittance T̅r̅(x,y)=e^{-∥x-y∥μ}^{ₜ}, which expresses the probability of the ray encountering no real or null collisions 216 within volumetric medium 202. Additionally, the medium radiance L^{m} is integrated from all points between x and y along the ray, weighted by the combined free-flight distribution p(t)=μₜe^{-tμ}^{ₜ}, which expresses the probability density of a collision (e.g., collisions 216) between the ray and a real or null particle at distance t.

The medium radiance can be computed using the following:

$${L}^{m} ( x , ω ) = \frac{{μ}_{a} ( x )}{{μ}_{t}} {L}_{e}^{m} ( x , ω ) + \frac{{μ}_{n} ( x )}{{μ}_{t}} L ( x , ω ) + \frac{{μ}_{s} ( x )}{{μ}_{t}} {\int }_{{s}^{2}} {ρ}_{m} ( ω , x , - {ω}^{′} ) L ( x , {ω}^{′} ) d {ω}^{′} \qquad ( 2 )$$

More specifically, the medium radiance is computed by summing the contributions from emission, null scattering in the forward direction, and integrated in-scattered radiance, which are represented by the first, second and third terms in Equation 2, respectively. The quantity α_{*}(x)=μ_{*}(x)/μₜ denotes the absorption, null, and scattering albedos for μ_{*}=μₐ, μ_{*}=μₙ, and μ_{*}=μₛ, respectively. The phase function ρₘ is the directional distribution of volumetric medium 202 and dictates how rays can scatter, given a location and incoming direction.

Monte Carlo rendering can be used to estimate the above integral equations using Monte Carlo sampling. Different sampling probability density functions (PDFs) can be applied to optimize specific types of light paths or specific parts of the integrand. For example, variance could be reduced compared to naïve unidirectional path tracing by tracing shadow rays toward light sources. In another example, Multiple Importance Sampling (MIS) could be used to combine multiple sampling techniques that use different directional PDFs for estimating the in-scattered radiance integral in Equation 2.

Additionally, by inserting Equation 2 into Equation 1 and recursively considering all forward null events, the Volterra integral formulation for the real transmittance can be obtained as:

$$Tr ( x , y ) = \overline{Tr} ( x , y ) + {\int }_{x}^{y} {α}_{n} ( t ) p ( t ) Tr ( t , y ) dt \qquad ( 3 )$$

The above formulation is computed when tracing shadow rays. Additionally, the null-scattering path integral can be used to perform MIS between different strategies for evaluating transmittance.

Those skilled in the art will appreciate that when a given upper bound μₜ is lower than the actual density of volumetric medium 202, thereby resulting in negative null density μₙ<0, renderings of volumetric medium 202 can have high and potentially unbounded variance. More specifically, Monte Carlo estimation can be applied directly to Equation 3 to produce the following:

$$〈 Tr ( x , y ) 〉 = \frac{\overline{Tr} ( x , y )}{{P}_{Tr}} + \frac{{α}_{n} ( t ) p ( t ) 〈 Tr ( t , y ) 〉}{{p}_{MC} ( t ) {P}_{rec}} \qquad ( 4 )$$

In the above equation, P_{Tr} is the probability that the first term is evaluated, P_{rec} is the probability that the recursive second term is evaluated, [symbol] Tr(x,y) [symbol] denotes an estimate of the quantity Tr(x,y), and p_{MC}(t) denotes the conditional probability density used to sample a distance t for the recursive integral. The MC subscript indicates that this conditional probability density is used for Monte Carlo and is generally distinct from the combined free-flight distribution p(t) in the integral equation.

The ratio tracking family of techniques is an example of how negative null density μₙ can adversely impact estimators for Equation 4. Ratio tracking involves sampling a tentative distance proportional to the combined free-flight distribution p(t) of volumetric medium 202. The first term of Equation 4 is evaluated only if a distance t>y is sampled, and the second term is evaluated only when t≤y is sampled. This manner of evaluation is equivalent to setting P_{Tr}=T̅r̅(x,y) and P_{rec}=1−T̅r̅(x,y). The conditional probability density of sampling a distance is p_{MC}(t)=p(t)/P_{rec}, where P_{rec} ensures that the PDF is properly normalized within the integration interval from x to y.

By inserting the above values into Equation 4, ratio tracking can be represented using the following:

$$〈 Tr ( x , y ) 〉 = {\prod }_{j = 1}^{m - 1} {α}_{n} ( {x}_{j} ) = {\prod }_{j = 1}^{m - 1} \frac{{μ}_{n} ( {x}_{j} )}{{μ}_{t}} = {\prod }_{j = 1}^{m - 1} \frac{{μ}_{t} - {μ}_{r} ( {x}_{j} )}{{μ}_{t}} \qquad ( 5 )$$

In the above equation, m is the total number of recursions or steps taken in Equation 4, and xⱼ is the jth ordered location along the ray. The resulting running product is a monotonically decreasing positive function when μₜ is bounding (i.e., μᵣ(x)<μₜ). However, this behavior does not hold when μₜ is non-bounding.

In particular, when μₜ<μᵣ(x)<2μₜ, the sign of the transmittance estimates computed using Equation 5 will begin to flip, but the absolute values of the transmittance estimates remain a monotonically decreasing function bounded within [−1,1] (since each term in the product is between −1 and 1). When μₜ is significantly non-bounding (i.e., when μᵣ(x)>2μₜ), the absolute magnitude of each term in Equation 5 will become greater than 1, thereby causing the running product (and hence the variance) to become unbounded as m increases.

An explosion in variance is similarly encountered when estimating the integral in the second term of Equation 1 using free-flight distance sampling routines, such as (but not limited to) delta tracking, weighted delta tracking, and/or decomposition tracking. These techniques estimate Equation 2 by assigning probabilities Pₐ, Pₙ, Pₛ to evaluate emission, null scattering, and in-scattered radiance, respectively:

$$〈 {L}^{m} ( x , ω ) 〉 = \frac{{μ}_{a} ( x )}{{μ}_{t}} \frac{{L}_{e}^{m} ( x , ω )}{{P}_{a}} + \frac{{μ}_{n} ( x )}{{μ}_{t}} \frac{L ( x , ω )}{{P}_{n}} + \frac{{μ}_{s} ( x )}{{μ}_{t}} \frac{{ρ}_{m} ( ω , x , - {ω}^{′} ) L ( x , {ω}^{′} )}{{p}_{MC} ( {ω}^{′} ) {P}_{s}} \qquad ( 6 )$$

Weighted delta tracking sets Pₐ, Pₙ, and Pₛ to:

$${P}_{*} ( x ) = \frac{{μ}_{*} ( x )}{{μ}_{r} ( x ) + \vert {μ}_{n} ( x ) \vert} \qquad ( 7 )$$

Inserting these probabilities leads to a shared factor of

$$\frac{{μ}_{r} ( x ) + \vert {μ}_{n} ( x ) \vert}{{μ}_{t}}$$

wat is multiplied will each of the three branches in Equation 6. When μₜ is non-bounding, this factor is greater than 1, and the weight (and variance) of the estimator grows exponentially with distance in a similar manner to ratio tracking.

As shown in FIG. 2, analysis engine 122 estimates transmittances 218 used to render volumetric medium 202 by computing one or more upper bounds 208 on the density of volumetric medium 202 based on real densities 206 evaluated at various locations 204 within volumetric medium 202. Analysis engine 122 also generates distributions 210 from upper bounds 208 and samples distances 214 from distributions 210. Analysis engine 122 additionally uses upper bounds 208 and distances 214 to determine real and null collisions 216 for the corresponding rays and computes transmittances 218 based on the determined collisions 216.

For example, analysis engine 122 could evaluate real densities 206 μᵣ(x) at one or more locations 204 x along a ray of light. Analysis engine 122 could use some or all of these real densities 206 to compute one or more upper bounds 208 μₜ on the density of volumetric medium 202. Next, analysis engine 122 could compute one or more ratios μᵣ(x)/μₜ as the proportion of real densities 206 to the corresponding upper bounds 208. Analysis engine 122 also generates one or more free-flight distributions 210 p(t)=μₜe^{-tμ}^{ₜ} from upper bounds 208, where a given free-flight distribution represents the likelihood of a ray experiencing a collision within volumetric medium 202, given a distance t traveled by the ray and upper bounds 208 μₜ. Analysis engine 122 samples from distributions 210 to determine free-flight distances 214 associated with the corresponding rays. Analysis engine 122 then uses the computed ratio(s) to probabilistically determine real or null collisions 216 associated with the free-flight distances 214 and computes transmittances 218 based on the ratios, free-flight distances 214, and/or the corresponding the real or null collisions 216. Each transmittance could represent the fraction of radiant energy at the beginning of the ray that reaches a corresponding distance (e.g., an endpoint of the ray).

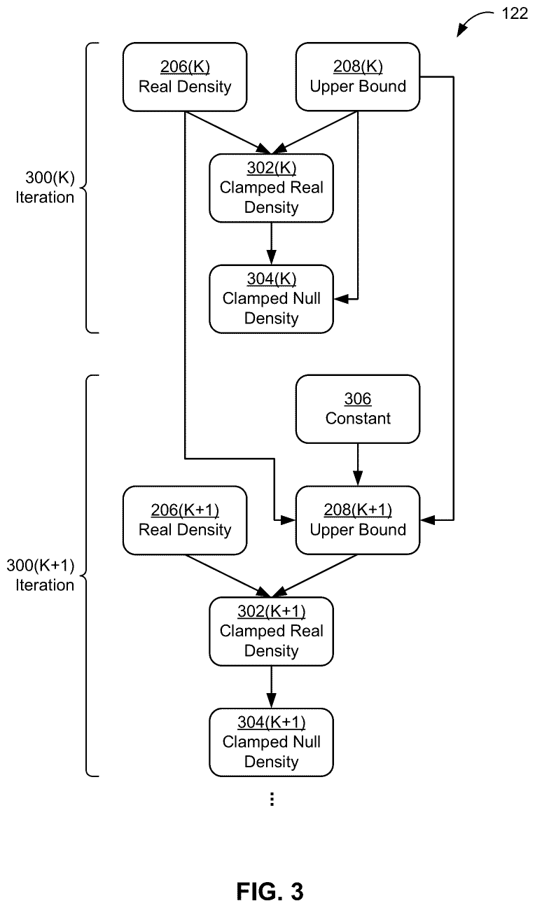

In one or more embodiments, analysis engine 122 iteratively determines a sequence of upper bounds 208 {μt^{(k)}}={μₜ⁽¹⁾, μₜ⁽²⁾, . . . , μₜ⁽ⁿ⁾} on the density of volumetric medium 202 in a manner that avoids non-bounding extinctions, as described in further detail below with respect to FIG. 3. Analysis engine 122 also uses upper bounds 208 and real densities 206 associated with each iteration to determine corresponding sets of collisions 216 and transmittances 218 associated with rays of light passing through volumetric medium 202.

FIG. 3 illustrates how analysis engine 122 of FIG. 1 iteratively evaluates densities associated with rendering of a volumetric medium, according to various embodiments. More specifically, FIG. 3 shows how analysis engine 122 determines and updates the densities over two consecutive iterations 300(K) and 300(K+1) (each of which is referred to individually herein as iteration 300).

During iteration 300(K), analysis engine 122 evaluates a real density 206(K) μᵣ(x^{(k)}) for volumetric medium 202 and computes an upper bound 208(K) on the density of volumetric medium 202, as denoted by uₜ^{(k)}. For example, analysis engine 122 could use simulations, procedural functions, and/or other techniques to determine real density 206(K) for a specific location corresponding to a free-flight distance of a ray that is sampled during iteration 300(K). Analysis engine 122 could also set upper bound 208(K) to a default value and/or a value that is equal to or higher than any previously determined real densities 206 for volumetric medium 202.

Analysis engine 122 also computes a clamped real density 302(K) using real density 206(K) and upper bound 208(K). In some embodiments, clamped real density 302(K) is denoted by uᵣ⁺(x^{(k)}) for iteration 300(K) and corresponds to a value for real density 206(K) that is restricted to a certain range of values. For example, clamped real density 302(K) could be set to a value that is the lower of real density 206(K) and upper bound 208(K):

$${μ}_{r}^{+} ( {x}^{( k )} ) = min ( {μ}_{r} ( {x}^{( k )} ) , {μ}_{t}^{( k )} ) \qquad ( 8 )$$

Analysis engine 122 then computes a clamped null density 304(K) uₙ⁺(x^{(k)}) as the difference between clamped real density 302(K) and upper bound 208(K):

$${μ}_{n}^{+} ( {x}^{( k )} ) = {μ}_{t}^{( k )} - {μ}_{r}^{+} ( {x}^{( k )} ) \qquad ( 9 )$$

Because clamped real density 302(K) is never higher than upper bound 208(K), clamped null density 304(K) is always non-negative.

Analysis engine 122 then computes, for a subsequent iteration 300(K+1), a corresponding upper bound 208(K+1) using upper bound 208(K) and real density 206(K) from the previous iteration 300(K) and a constant 306. For example, analysis engine 122 could compute upper bound 208(K+1), as denoted by μₜ^{(k+1)}, as the higher of the previous upper bound 208(K) and the sum of real density 206(K) evaluated for a location x^{(k)} in the previous iteration 300(K) and a small positive constant 306 ϵ:

$${μ}_{t}^{( k + 1 )} = {max}_{∀ {x}^{( k )}} ( {μ}_{t}^{( k )} , {μ}_{r} ( {x}^{( k )} ) + ϵ ) \qquad ( 10 )$$

Analysis engine 122 also uses Equations 8 and 9 to compute a corresponding clamped real density 302(K+1) and clamped null density 304(K+1) from upper bound 208(K+1) and real density 206(K+1).

The operation of analysis engine 122 in performing density evaluations across iterations can be represented by the following example pseudocode:

```
EvaluateDensity(μₜ^{(k)}, o, ω, t)
  Input: μₜ^{(k)}, ray origin o, ray direction ω, distance t
  μᵣ⁺ ← min(μᵣ (o + tω), μₜ^{(k)})
  μₜ^{(k+1)} ← max(μₜ^{(k)}, μᵣ (o + tω) + ∈)
  return μᵣ⁺, μₜ^{(k+1)}
```

The above pseudocode includes a name of “EvaluateDensity.” The pseudocode operates on input that includes upper bound 208(K) μₜ^{(k)} and a location corresponding to an origin o, a direction ω, and a distance t associated with a ray. Given this input, analysis engine 122 computes clamped real density 302(K) as the lower of a real density 206(K) evaluated at the location and upper bound 208(K). Next, analysis engine 122 computes upper bound 208(K+1) as the higher of upper bound 208(K) and the sum of the real density 206(K) evaluated at the location and constant 306 ϵ. Analysis engine 122 then returns clamped real density 302(K) for the current iteration and upper bound 208(K+1) for the next iteration. As long as there is a non-zero measure of points within ϵ of the maximum density of volumetric medium 202, analysis engine 122 is capable of finding a bounding extinction in finite time.

Analysis engine 122 can perform additional iterations (not shown) to generate additional real densities 206, upper bounds 208, clamped real densities 302, and clamped null densities 304. For example, analysis engine 122 could generate a sequence of N non-decreasing upper bounds 208 over N corresponding iterations 300. As upper bounds 208 are updated over the iterations, estimates of transmittance determined using upper bounds 208 become progressively unbiased.

While the operation of analysis engine 122 has been described above with respect to a single upper bound 208(K) and 208(K+1) per respective iteration 300(K) and 300(K+1), it will be appreciated that multiple upper bounds 208 can be computed for each iteration. For example, analysis engine 122 could subdivide volumetric medium 202 into a super-voxel grid, octree, and/or another set of discrete regions. At each iteration, analysis engine 122 could independently store and update upper bounds 208 for each region, thereby allowing upper bounds 208 to form a piecewise function for any path through volumetric medium 202 and reflect variations in real densities 206 within volumetric medium 202.

Additionally, it will be appreciated that upper bounds 208 can be computed in various ways over multiple iterations. For example, a given upper bound 208(K+1) could be computed to be lower than the previous upper bound 208(K) if the previous upper bound is estimated to be significantly larger than the corresponding real density 206(K) to improve the efficiency with which null-collision-based rendering of volumetric medium 202 is performed.

Returning to the discussion of FIG. 2, rendering engine 124 generates a different rendered image 230 for each iteration performed by analysis engine 122. More specifically, rendering engine 124 uses collisions 216 and/or transmittances 218 determined by analysis engine 122 over N iterations to compute contributions 222(1)-222(N) (each of which is referred to individually herein as contributions 222) from the corresponding rays of light to pixel values 224(1)-224(X) and 224(N*X−X−1)-224(N*X) (each of which is referred to individually herein as pixel value 224) in rendered images 230(1)-230(N) (each of which is referred to individually herein as rendered image 230). Rendered image 230(1) includes pixel values 224(1)-224(X) that are determined using color and light intensity contributions 222(1) associated with collisions 216 and transmittances 218 from the first iteration, and rendered image 230(N) includes pixel values 224(N*X−X−1)-224(N*X) that are determined using color and light intensity contributions 222(N) associated with collisions 216 and transmittances 218 from the last (i.e., Nth) iteration. Consequently, each iteration performed by analysis engine 122 corresponds to a different rendering pass performed by rendering engine 124.

Rendering engine 124 then aggregates pixel values 224 from rendered images 230 into rendering output 232 that corresponds to a final rendered image of volumetric medium 202. Pixel values 234(1)-234(X) (each of which is referred to individually herein as pixel value 234) in rendering output 232 can be determined as an average of corresponding pixel values 224 from rendered images 230:

$$〈 I 〉 = \frac{1}{n} {\sum }_{k = 1}^{n} 〈 I ( {μ}_{t}^{( k )} ) 〉 \qquad ( 11 )$$

In the above equation, [symbol] I [symbol] represents rendering output 232 and is computed as the average of N rendered images 230, and μₜ^{(k)} corresponds to one or more upper bounds 208 used to render image k. As long as μₜ^{(k)} bounds the corresponding real densities 206 after some finite iteration j, the bias in rendering output 232 decreases as n increases, since subsequent unbiased iterations will effectively override any bias accumulated from the first j iterations.

Pixel values 234 in rendering output 232 can also, or instead, be computed as a weighted average of pixel values 224 from rendered images 230. For example, each set of pixel values 224 in the weighted average could be weighted by the number of samples used to render the corresponding rendered image 230 and/or by other values.

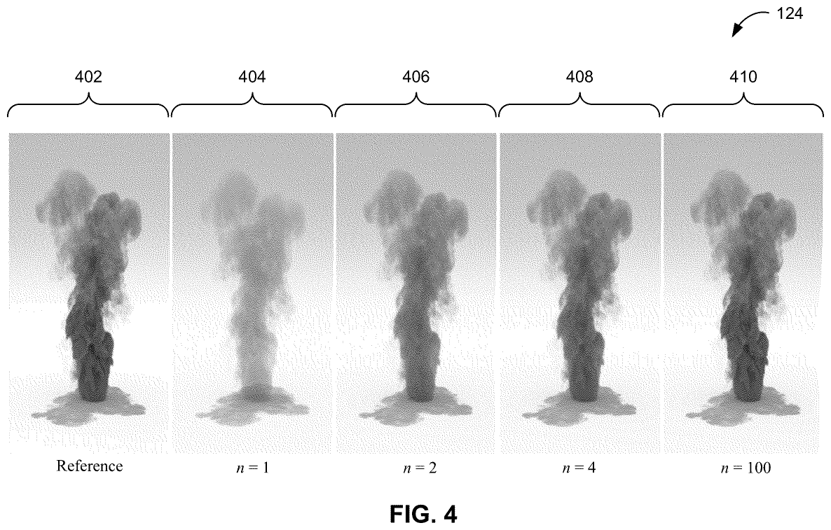

FIG. 4 illustrates a set of example rendered images 402, 404, 406, 408, and 410 of a volumetric medium (e.g., volumetric medium 202 of FIG. 2), according to various embodiments. More specifically, FIG. 4 shows five rendered images 402, 404, 406, 408, and 410 that depict the same volumetric medium. Rendered image 402 is a reference image of the volumetric medium, rendered image 404 corresponds to rendering output 232 that is generated after a single iteration, rendered image 406 corresponds to rendering output 232 that is generated after two iterations, rendered image 408 corresponds to rendering output 232 that is after four iterations, and rendered image 410 corresponds to rendering output 232 that is generated after 100 iterations.

As shown in FIG. 4, rendered images 404, 406, 408, and 410 show a convergence toward rendered image 402. In particular, rendered image 404 includes a loss of detail that is caused by clamping the real density of the volumetric medium to avoid a negative null density. Rendered image 406 is generated by averaging rendered image 404 and a second rendered image (not shown) that is generated using a null density and upper bound on density that reflect real densities evaluated during generation of rendered image 404. Rendered image 408 is generated by averaging the two images used to produce rendered image 406 and two additional images (not shown) that are generated using corresponding null densities and upper bounds on density. Consequently, rendered image 406 includes more detail and less bias than rendered image 404, and rendered image 408 includes more detail and less bias than rendered image 406.

Rendered image 410 is generated by averaging 100 rendered images that are generated using a non-decreasing sequence of corresponding upper bounds on the density of the volumetric medium. For example, the 100 rendered images could include rendered image 404, the second rendered image that is averaged with rendered image 404 to produce rendered image 406, the two additional images that are averaged with the first two rendered images to produce rendered image 408, and 96 additional rendered images of the volumetric medium. Each rendered image could be generated by determining collisions and transmittances associated with rays propagating within the volumetric medium using a corresponding bounding value and clamped real density that is determined using the “EvaluateDensity” technique. Once a real density that is within ϵ of the maximum real density of the volumetric medium is evaluated, subsequent upper bounds 208 in the sequence successfully bound the real densities of the volumetric medium. Because rendered image 410 includes pixel values from unbiased renderings of the volumetric medium generated using these subsequent bounding values, rendered image 410 is significantly more similar to the reference image than rendered images 404, 406, or 408.

Returning to the discussion of FIG. 2, as discussed above, analysis engine 122 can sample free-flight distances 214 from one or more distributions 210 that are directly proportional to the free-flight distribution p(t)=μₜe^{-tμ}^{ₜ}, which expresses the probability density of a collision occurring with a real or null particle at distance t. However, this type of sampling is not optimal.

More specifically, assuming a bounding extinction μₜ≥μᵣ and a homogeneous real density, a zero-variance estimator for ratio tracking can be formulated by sampling distances proportional to:

$${p}_{MC} ( t ) = {μ}_{n} ( x , t ) , where ( x , t ) = {e}^{- {μ}_{n} t} = \frac{\overline{Tr} ( x , t )}{Tr ( x , t )} \qquad ( 12 )$$

This can be confirmed by plugging Equation 12 into Equation 4:

$$〈 Tr ( x , y ) 〉 = \frac{\overline{Tr} ( x , y )}{{P}_{Tr}} + \frac{{α}_{n} ( t ) p ( t ) 〈 Tr ( t , y ) 〉}{{μ}_{n} ( x , t ) {P}_{rec}} \qquad ( 13 )$$

Because ratio tracking obtains P_{rec} and P_{Tr} by integrating and renormalizing p_{MC}(t), Equation 13 simplifies to:

$$〈 Tr ( x , y ) 〉 = Tr ( x , y ) + Tr ( x , t ) 〈 Tr ( t , y ) 〉 \qquad ( 14 )$$

which always returns the exact transmittance. In ratio tracking, only the first term or the second term on the right-hand side of Equation 14 is evaluated.

This result indicates that instead of sampling distances t proportional to the total free-flight distribution (as performed in standard ratio tracking), zero variance can be obtained by sampling according to a “null free-flight distribution” in Equation 12. While this is not feasible, as μₙ=μₙ(x) is an unknown, spatially varying function, this suggests that ratio tracking can be improved by decoupling the combined free-flight distribution of volumetric medium 202 from the distribution used to sample free-flight distances 214.

Accordingly, in some embodiments, analysis engine 122 performs an importance-sampled form of ratio tracking, which sets p_{MC}(t) for the next recursion of Equation 4 to be proportional to Equation 12 and uses the clamped null density μ_{MC}=μₙ⁺(x) from the current recursion as a proxy for the true null density μₙ.

The operation of analysis engine 122 in performing the importance-sampled form of ratio tracking can be represented by the following example pseudocode:

```
AdaptiveRatio Tracking(μₜ^{(k)}, o, ω, d)
  Input: μₜ^{(k)}, ray origin o, ray direction ω, medium length d
  T ← 1
  t ← 0
  μ_{MC} ← μₜ^{(k)}
  while t < d and μ_{MC} > 0 do
  $x ← min ( - \frac{ln ( 1 - u )}{{μ}_{MC}} , d - t )$
  T ← T * exp ((μ_{MC} − μₜ^{(k)}) * x)
  if x ≠ d − t then
    t ← t + x
    μᵣ⁺, μₜ^{(k+1)} = EvaluateDensity(μₜ^{(k)}, o, ω, t)
    T ← T * (μₜ^{(k)} − μᵣ⁺)/μ_{MC}
    μ_{MC} ← μₜ^{(k)} − μᵣ⁺
return T, μₜ^{(k+1)}
```

The above pseudocode includes a name of “AdaptiveRatioTracking” and operates on input that includes the kth upper bound 208, o and ω for a ray, and a length of volumetric medium 202 d. Given this input, analysis engine 122 initializes transmittance T to 1 (representing full light transmission), distance t to 0, and μ_{MC} to the inputted upper bound μₜ^{(k)}. Next, analysis engine 122 enters a while loop that performs sampling until the ray travels the full length of the medium (i.e., t≥d) or μ_{MC} is set to zero.

In each iteration of the while loop, analysis engine 122 samples a free-flight distance x as the minimum of the distance derived from

$$- \frac{ln ( 1 - u )}{{μ}_{MC}} ,$$

where u is a random number, and the remaining distance d-t within volumetric medium 202. Analysis engine 122 also updates the transmittance T as the product of the current transmittance and an exponential function exp((μ_{MC}−μₜ^{(k)})*x). In the first iteration, this exponential function evaluates to 1 because μ_{MC}=μₜ^{(k)}. Because T is initialized to 1 before the while loop, the updated value of T in the first iteration is also 1.

Next, analysis engine 122 determines whether or not the sampled distance x has reached the end of volumetric medium 202, as determined by d−t. If the sampled distance corresponds to a location within volumetric medium 202, analysis engine 122 updates the distance traveled by the ray t with the sampled distance x. Analysis engine 122 also uses the “EvaluateDensity” function to compute a clamped real density for the current iteration of the while loop and an upper bound on the density for the next iteration of the while loop. Analysis engine 122 further adjusts the transmittance T as a product of the current transmittance and the ratio of the clamped null density μₙ⁺(x)=μₜ^{(k)}−μᵣ⁺ to μ_{MC}. Analysis engine 122 additionally updates μ_{MC} for the next iteration to the clamped null density μₙ⁺(x).

Analysis engine 122 performs additional iterations of the while loop until the ray reaches the end of volumetric medium 202 and/or μ_{MC} reaches 0. Finally, analysis engine 122 returns the transmittance T and the final upper bound μₜ^{(k+1)}.

While the operation of analysis engine 122 has been described above with respect to sampling free-flight distances 214 from a “null free-flight distribution” that is parameterized using the clamped null density μ_{MC}=μₙ⁺(x), it will be appreciated that analysis engine 122 can sample free-flight distances 214 from other types of distributions. For example, analysis engine 122 could compute μ_{MC} as the difference between the upper bound on the density of volumetric medium 202 and the real density sampled at a given location in volumetric medium 202, or μₜ−μᵣ. Analysis engine 122 could then sample free-flight distances, transmittances, and/or other values using this null density instead of the clamped null density.

By sampling free-flight distances using an exponential distribution that approximates the “null free-flight distribution” using a null density μ_{MC} that is iteratively updated, analysis engine 122 can lower the variance associated with transmittance estimate using ratio tracking techniques. More specifically, analysis engine 122 approximates the sampling of collisions 216 in the null portion of volumetric medium 202, which allows a value that is closer to the true transmittance to be determined for a given interval along the path of the ray than collisions 216 for which transmittance values are determined by sampling collisions 216 from the sum of real and null particles in volumetric medium 202.

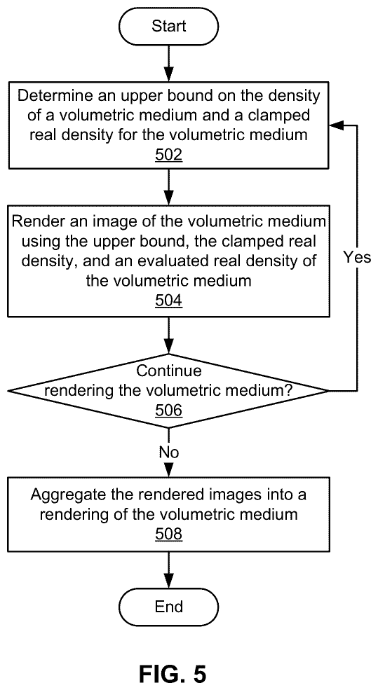

FIG. 5 sets forth a flow diagram of method steps for rendering a volumetric medium using a sequence of upper bounds on the density of the volumetric medium, according to various embodiments. Although the method steps are described in conjunction with the systems of FIGS. 1-2, persons skilled in the art will understand that any system configured to perform the method steps in any order falls within the scope of the present disclosure.

As shown, in step 502, analysis engine 122 determines an upper bound on the density of a volumetric medium and a clamped real density for the volumetric medium. For example, analysis engine 122 could initially set the upper bound to a default value and/or a value that reflects previously evaluated real densities for the volumetric medium. Analysis engine 122 could also set the clamped real density to the lower of the upper bound and an evaluated real density for the volumetric medium. Analysis engine 122 could additionally compute an upper bound for the next iteration using the upper bound for the current iteration and the evaluated real density for the current iteration.

In step 504, analysis engine 122 and rendering engine 124 render an image of the volumetric medium using the upper bound, the clamped real density, and an evaluated real density of the volumetric medium. For example, analysis engine 122 could use one or more null-collision-based tracking techniques to estimate free flight distances, collisions, and transmittances for rays propagating within the volumetric medium based on the upper bound and clamped real density. Rendering engine 124 could use the estimated transmittances to determine contributions of the rays to light intensities and colors in the image.

In step 506, analysis engine 122 determines whether or not to continue rendering the volumetric medium. For example, analysis engine 122 could determine that rendering of the volumetric medium should continue over a certain number of iterations, until the upper bound on the density stops increasing for a certain number of iterations, until differences between consecutive images fall below a threshold, and/or until another condition is met.

While analysis engine 122 determines that rendering of the volumetric medium is to continue, analysis engine 122 and rendering engine 124 repeat steps 502 and 504. More specifically, analysis engine 122 performs step 502 to set a new upper bound (e.g., to the value computed in the previous iteration of step 502) based on real densities evaluated during the previous iteration. Analysis engine 122 also computes a clamped real density for the volumetric medium using the new upper bound and real densities evaluated during the current iteration. Analysis engine 122 and rendering engine 124 also perform step 504 to render a new image of the volumetric medium using free flight distances, collisions, and transmittances that are computed using the new upper bound and clamped real density.

Analysis engine 122 additionally repeats step 506 after rendering of each new image is complete to determine whether or not to continue rendering additional images of the volumetric medium. Once analysis engine 122 determines that rendering of the medium is to be discontinued, rendering engine 124 performs step 508, in which rendering engine 124 aggregates the rendered images into a rendering of the volumetric medium. For example, rendering engine 124 could generate the rendering as an average of all images rendered using steps 502 and 504. Rendering engine 124 could also, or instead, exclude a subset of images (e.g., one or more images that were rendered using upper bounds that are lower than the evaluated densities associated with subsequent images) from the average. Rendering engine 124 could also, or instead, generate a weighted average of images rendered during steps 502 and 504, such that the weight associated with an image is inversely proportional to the position of the image in the sequence.

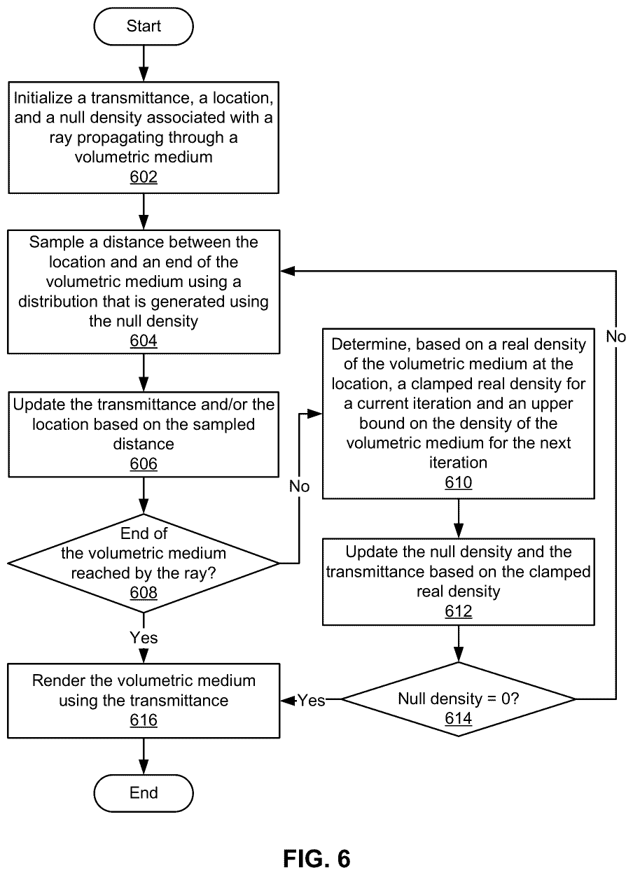

FIG. 6 sets forth a flow diagram of method steps for rendering a volumetric medium using an approximation of a null free-flight distribution, according to various embodiments. Although the method steps are described in conjunction with the systems of FIGS. 1-2, persons skilled in the art will understand that any system configured to perform the method steps in any order falls within the scope of the present disclosure.

As shown, in step 602, analysis engine 122 initializes a transmittance, a location, and a null density associated with a ray propagating through the volumetric medium. For example, analysis engine 122 could initialize the transmittance T to 1, the location t to a point at which the ray originates, and the null density μ_{MC} to an upper bound on the density of the volumetric medium for a current iteration.

In step 604, analysis engine 122 samples a distance between the location and an end of the volumetric medium using a distribution that is generated using the null density. For example, analysis engine 122 could sample the distance from an exponential distribution that is parameterized using the null density (e.g., by drawing a random number u and computing the distance as −ln(1−u)/μ_{MC}). Analysis engine 122 could also limit the distance to the remaining distance between the location and the end of the volumetric medium.

In step 606, analysis engine 122 updates the transmittance and/or the location based on the sampled distance. For example, analysis engine 122 could update the transmittance by multiplying the transmittance by an exponential of the distance scaled by a difference between the clamped null density and the upper bound. Analysis engine 122 could also move the location by the sampled distance.

In step 608, analysis engine 122 determines whether or not the end of the volumetric medium is reached by the ray. For example, analysis engine 122 could determine that the end of the volumetric medium is reached by the ray if the location of the ray corresponds to a boundary of the volumetric medium. If analysis engine 122 determines that the ray has reached the end of the volumetric medium, rendering engine 124 performs step 616, in which rendering engine 124 renders the volumetric medium using the transmittance. For example, rendering engine 124 could render an image of the volumetric medium for a current rendering pass.

If analysis engine 122 determines that the end of the volumetric medium is not reached by the ray, analysis engine 122 performs step 610, in which analysis engine 122 determines, based on a real density of the volumetric medium at the location, a clamped real density for the current iteration and an upper bound on the density of the volumetric medium for the next iteration. For example, analysis engine 122 could determine the upper bound as the higher of the upper bound for the current iteration and the real density evaluated at the location. Analysis engine 122 could also compute the clamped real density as the lower of the real density and the upper bound.

In step 612, analysis engine 122 updates the null density and the transmittance based on the clamped real density. For example, analysis engine 122 could compute an updated null density as a difference between the upper bound on the density of the volumetric medium for the current iteration and the clamped real density determined in step 610. Alternatively, analysis engine 122 could compute an updated null density as the difference between the upper bound on the density of the volumetric medium for the current iteration and the real density evaluated at the location. Analysis engine 122 could also scale the transmittance by the ratio between the updated null density and the previous null density.

In step 614, analysis engine 122 determines whether or not the null density has reached 0. If so (e.g., if the null density has reached 0), rendering engine 124 performs step 616 to render the volumetric medium using the transmittance.

If the null density has not reached 0 (e.g., if the null density continues to be greater than 0), analysis engine 122 repeats steps 604 and 606 to sample another distance and move to another location on the ray by that distance. Analysis engine 122 also repeats step 608 to determine if the other location corresponds to the end of the volumetric medium. If so, rendering engine 124 performs step 616 to render the volumetric medium using the current value of the transmittance. While the location of the ray has not reached the end of the volumetric medium, analysis engine 122 repeats steps 610 and 612 to update the clamped real density, the upper bound for the next rendering pass, the null density, and the transmittance. Rendering engine 124 additionally performs step 614 to determine whether or not the null density has reached 0. Once the null density has reached 0 and/or the end of the volumetric medium is reached by the ray, rendering engine 124 performs step 616 to render the volumetric medium using the transmittance associated with the ray.

In sum, the disclosed techniques use a progressive null tracking technique to render a volumetric medium. A sequence of values for an upper bound on the density of the volumetric medium is iteratively computed. During a given iteration, the upper bound is computed using density values for the volumetric medium from the previous iteration and the upper bound from the previous iteration. Each upper bound is also used to sample distances for rays of light traveling through the volumetric medium, determine real and null collisions associated with the free flight distances, and determine transmittances associated with the ray.

A different image of the volumetric medium is rendered during each iteration based on density values, upper bounds, collisions, and/or other attributes associated with interactions between light and the volumetric medium. More specifically, transmittances determined over a given iteration are used to determine contributions of individual rays to light intensities, colors, and/or other pixel values in a corresponding image. Multiple rendered images generated over multiple corresponding iterations are also aggregated into a final render output.

One technical advantage of the disclosed techniques relative to the prior art is the ability to converge on the correct upper bound on the density of a volumetric medium over a finite number of iterations. Accordingly, the disclosed techniques allow null-collision-based rendering techniques to become resilient to underestimates of the upper bound, thereby improving rendering quality over conventional volumetric rendering techniques that introduce bias and/or variance in the presence of non-bounding majorants. Another technical advantage of the disclosed techniques is the ability to perform volumetric rendering without a priori knowledge about the density of a volumetric medium. Consequently, the disclosed techniques are more computationally efficient than conventional null-collision-based rendering techniques that specify loose upper bounds on the density of a volumetric medium and/or precompute and store density values at various locations in the volumetric medium. These technical advantages provide one or more technological improvements over prior art approaches.
1. In some embodiments, a computer-implemented method for rendering a volumetric medium comprises generating, in a first rendering pass, a first set of pixel values associated with rendering the volumetric medium using a first upper bound on a density of the volumetric medium; generating, in a second rendering pass, a second set of pixel values associated with rendering the volumetric medium using a second upper bound on the density of the volumetric medium, wherein the second upper bound is different from the first upper bound; and generating a rendering of the volumetric medium based on the first set of pixel values and the second set of pixel values.
2. The computer-implemented method of clause 1, further comprising computing the second upper bound based on the first upper bound and a real density of the volumetric medium.
3. The computer-implemented method of any of clauses 1-2, wherein the second upper bound is computed as a higher of (i) the first upper bound and (ii) a sum of the real density and a positive constant when the real density of the volumetric medium from the first rendering pass is greater than the first upper bound.
4. The computer-implemented method of any of clauses 1-3, further comprising generating, in a plurality of additional rendering passes, a plurality of additional sets of pixel values associated with rendering the volumetric medium, wherein each rendering pass included in the plurality of additional rendering passes is executed using a corresponding upper bound on the density of the volumetric medium that is equal to or higher than the second upper bound; and generating the rendering of the volumetric medium based on an aggregation of the plurality of additional sets of pixel values, the first set of pixel values, and the second set of pixel values.
5. The computer-implemented method of any of clauses 1-4, further comprising computing a clamped real density of the volumetric medium based on a real density of the volumetric medium and the first upper bound for the density of the volumetric medium; and generating the first set of pixel values based on the clamped real density of the volumetric medium.
6. The computer-implemented method of any of clauses 1-5, wherein the clamped real density is computed to not exceed the first upper bound.
7. The computer-implemented method of any of clauses 1-6, wherein generating the first set of pixel values based on the clamped real density of the volumetric medium comprises determining a transmittance associated with a ray propagating within the volumetric medium based on the clamped real density and the first upper bound.
8. The computer-implemented method of any of clauses 1-7, wherein the rendering is generated based on an average of the first set of pixel values and the second set of pixel values.
9. The computer-implemented method of any of clauses 1-8, wherein the first upper bound and the second upper bound are computed for a region within the volumetric medium.
10. The computer-implemented method of any of clauses 1-9, wherein the first upper bound is lower than a set of sampled values for the density of the volumetric medium and the second upper bound is higher than or equal to the set of sampled values for the density of the volumetric medium.
11. In some embodiments, one or more non-transitory computer-readable media store instructions that, when executed by one or more processors, cause the one or more processors to perform the steps of generating, in a first rendering pass, a first set of pixel values associated with rendering a volumetric medium using a first upper bound for a density of the volumetric medium; generating, in a second rendering pass, a second set of pixel values associated with rendering the volumetric medium using a second upper bound for the density of the volumetric medium, wherein the second upper bound is different from the first upper bound; and generating a rendering of the volumetric medium based on the first set of pixel values and the second set of pixel values.
12. The one or more non-transitory computer-readable media of clause 11, wherein the instructions further cause the one or more processors to perform the step of computing the second upper bound as a maximum of (i) the first upper bound and (ii) a positive constant summed with a real density of the volumetric medium that is determined during the first rendering pass.
13. The one or more non-transitory computer-readable media of any of clauses 11-12, wherein the instructions further cause the one or more processors to perform the steps of computing a clamped real density of the volumetric medium based on a real density of the volumetric medium and the first upper bound for the density of the volumetric medium; and generating the first set of pixel values based on the clamped real density of the volumetric medium.
14. The one or more non-transitory computer-readable media of any of clauses 11-13, wherein the clamped real density is computed as a lower of the real density and the first upper bound.
15. The one or more non-transitory computer-readable media of any of clauses 11-14, wherein generating the second set of pixel values based on the clamped real density of the volumetric medium comprises determining a distance associated with a ray propagating within the volumetric medium based on a clamped null density corresponding to the clamped real density and the second upper bound.
16. The one or more non-transitory computer-readable media of any of clauses 11-15, wherein the instructions further cause the one or more processors to perform the steps of generating, in a plurality of additional rendering passes, a plurality of additional sets of pixel values associated with rendering the volumetric medium, wherein each rendering pass included in the plurality of additional rendering passes is executed using a corresponding upper bound on the density of the volumetric medium that is equal to or higher than the second upper bound; and generating the rendering of the volumetric medium based on an aggregation of the plurality of additional sets of pixel values, the first set of pixel values, and the second set of pixel values.
17. The one or more non-transitory computer-readable media of any of clauses 11-16, wherein the aggregation comprises a weighted average of the plurality of additional sets of pixel values, the first set of pixel values, and the second set of pixel values.
18. The one or more non-transitory computer-readable media of any of clauses 11-17, wherein the first upper bound and the second upper bound are computed for a region within the volumetric medium.
19. The one or more non-transitory computer-readable media of any of clauses 11-18, wherein the first upper bound is lower than a set of sampled values for the density of the volumetric medium and the second upper bound is higher than or equal to the set of sampled values for the density of the volumetric medium.
20. In some embodiments, a system comprises one or more memories that store instructions, and one or more processors that are coupled to the one or more memories and, when executing the instructions, are configured to perform the steps of generating, in a first rendering pass, a first set of pixel values associated with rendering a volumetric medium using a first upper bound for a density of the volumetric medium; generating, in a second rendering pass, a second set of pixel values associated with rendering the volumetric medium using a second upper bound for the density of the volumetric medium, wherein the second upper bound is different from the first upper bound; and generating a rendering of the volumetric medium based on the first set of pixel values and the second set of pixel values.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for rendering a volumetric medium, the method comprising:
generating, in a first rendering pass, a first set of pixel values associated with rendering the volumetric medium using a first upper bound on a density of the volumetric medium;
generating, in a second rendering pass, a second set of pixel values associated with rendering the volumetric medium using a second upper bound on the density of the volumetric medium, wherein the second upper bound is different from the first upper bound; and
generating a rendering of the volumetric medium based on the first set of pixel values and the second set of pixel values.

2. The computer-implemented method of claim 1, further comprising computing the second upper bound based on the first upper bound and a real density of the volumetric medium.

3. The computer-implemented method of claim 2, wherein the second upper bound is computed as a higher of (i) the first upper bound and (ii) a sum of the real density and a positive constant when the real density of the volumetric medium from the first rendering pass is greater than the first upper bound.

4. The computer-implemented method of claim 1, further comprising:
generating, in a plurality of additional rendering passes, a plurality of additional sets of pixel values associated with rendering the volumetric medium, wherein each rendering pass included in the plurality of additional rendering passes is executed using a corresponding upper bound on the density of the volumetric medium that is equal to or higher than the second upper bound; and
generating the rendering of the volumetric medium based on an aggregation of the plurality of additional sets of pixel values, the first set of pixel values, and the second set of pixel values.

5. The computer-implemented method of claim 1, further comprising:
computing a clamped real density of the volumetric medium based on a real density of the volumetric medium and the first upper bound for the density of the volumetric medium; and
generating the first set of pixel values based on the clamped real density of the volumetric medium.

6. The computer-implemented method of claim 5, wherein the clamped real density is computed to not exceed the first upper bound.

7. The computer-implemented method of claim 5, wherein generating the first set of pixel values based on the clamped real density of the volumetric medium comprises determining a transmittance associated with a ray propagating within the volumetric medium based on the clamped real density and the first upper bound.

8. The computer-implemented method of claim 1, wherein the rendering is generated based on an average of the first set of pixel values and the second set of pixel values.

9. The computer-implemented method of claim 1, wherein the first upper bound and the second upper bound are computed for a region within the volumetric medium.

10. The computer-implemented method of claim 1, wherein the first upper bound is lower than a set of sampled values for the density of the volumetric medium and the second upper bound is higher than or equal to the set of sampled values for the density of the volumetric medium.

11. One or more non-transitory computer-readable media storing instructions that, when executed by one or more processors, cause the one or more processors to perform the steps of:
generating, in a first rendering pass, a first set of pixel values associated with rendering a volumetric medium using a first upper bound for a density of the volumetric medium;
generating, in a second rendering pass, a second set of pixel values associated with rendering the volumetric medium using a second upper bound for the density of the volumetric medium, wherein the second upper bound is different from the first upper bound; and
generating a rendering of the volumetric medium based on the first set of pixel values and the second set of pixel values.

12. The one or more non-transitory computer-readable media of claim 11, wherein the instructions further cause the one or more processors to perform the step of computing the second upper bound as a maximum of (i) the first upper bound and (ii) a positive constant summed with a real density of the volumetric medium that is determined during the first rendering pass.

13. The one or more non-transitory computer-readable media of claim 11, wherein the instructions further cause the one or more processors to perform the steps of:
computing a clamped real density of the volumetric medium based on a real density of the volumetric medium and the first upper bound for the density of the volumetric medium; and
generating the first set of pixel values based on the clamped real density of the volumetric medium.

14. The one or more non-transitory computer-readable media of claim 13, wherein the clamped real density is computed as a lower of the real density and the first upper bound.

15. The one or more non-transitory computer-readable media of claim 13, wherein generating the second set of pixel values based on the clamped real density of the volumetric medium comprises determining a distance associated with a ray propagating within the volumetric medium based on a clamped null density corresponding to the clamped real density and the second upper bound.

16. The one or more non-transitory computer-readable media of claim 11, wherein the instructions further cause the one or more processors to perform the steps of:
generating, in a plurality of additional rendering passes, a plurality of additional sets of pixel values associated with rendering the volumetric medium, wherein each rendering pass included in the plurality of additional rendering passes is executed using a corresponding upper bound on the density of the volumetric medium that is equal to or higher than the second upper bound; and
generating the rendering of the volumetric medium based on an aggregation of the plurality of additional sets of pixel values, the first set of pixel values, and the second set of pixel values.

17. The one or more non-transitory computer-readable media of claim 16, wherein the aggregation comprises a weighted average of the plurality of additional sets of pixel values, the first set of pixel values, and the second set of pixel values.

18. The one or more non-transitory computer-readable media of claim 11, wherein the first upper bound and the second upper bound are computed for a region within the volumetric medium.

19. The one or more non-transitory computer-readable media of claim 11, wherein the first upper bound is lower than a set of sampled values for the density of the volumetric medium and the second upper bound is higher than or equal to the set of sampled values for the density of the volumetric medium.

20. A system, comprising:
one or more memories that store instructions, and
one or more processors that are coupled to the one or more memories and, when executing the instructions, are configured to perform the steps of:
generating, in a first rendering pass, a first set of pixel values associated with rendering a volumetric medium using a first upper bound for a density of the volumetric medium;
generating, in a second rendering pass, a second set of pixel values associated with rendering the volumetric medium using a second upper bound for the density of the volumetric medium, wherein the second upper bound is different from the first upper bound; and
generating a rendering of the volumetric medium based on the first set of pixel values and the second set of pixel values.
